(19) United States
(12) Patent Application Publication
(10) Pub. No.: US 2024/0420024 A1
(43) Pub. Date: Dec. 19, 2024

(54) METHOD OF GENERATING A CLASSIFICATION MODEL

(71) Applicant: STMicroelectronics International N.V., Geneva (CH)

(72) Inventor: He Huang, Paris (FR)

(21) Appl. No.: 18/657,414

(22) Filed: May 7, 2024

(30) Foreign Application Priority Data
Jun. 14, 2023 (FR) 2306062

(51) Int. Cl. G06N 20/00

(52) U.S. Cl. CPC G06N 20/00

(57) ABSTRACT

A method for creating a classification model includes: obtaining at least one group of initial time-series signals associated with at least one initial acquisition parameter, creating at least one group of simulated time-series signals from the at least one group of initial time-series signals, creating various test classification models, from groups of initial or simulated time-series signals, assessing the performances of each test classification model, obtaining at least one group of final time-series signals associated with at least one final acquisition parameter, and creating the classification model.

### CROSS-REFERENCE TO RELATED APPLICATIONS

This application claims the benefit of French Patent Application No. 2306062, filed on Jun. 14, 2023, which application is hereby incorporated herein by reference.

### TECHNICAL FIELD

The present invention relates generally to learning data, and, in particular embodiments, to a method of generating a classification model.

### BACKGROUND

Computers may use classification models to classify data into categories or groups depending on certain features. Several types of classification models exist. Each type of classification model has its own advantages and disadvantages depending on the type of data to be classified.

Classification models particularly include decision trees, neural networks, classification models based on neighbors, such as the k-nearest neighbor (KNN), and support-vector machines (SVM).

Classification models may be used for time-series signals. Time-series signals are data that change over time and contain a measurement or an observation at each acquisition instant.

A time-series signal may for example correspond to an audio signal, a video signal, a vibration signal or a physiological signal.

In particular, time-series signals may be acquired according to various acquisition parameters. For example, time-series signals may be acquired according to a sampling frequency and an amount of data set by a user.

The sampling frequency corresponds to a number of data samples of the time-series signal per unit of time. The higher the sampling frequency for the same amount of data, the higher the resolution is of the time-series signals in the time domain, this resolution corresponding to the value of the sampling frequency divided by the amount of data. Conversely, a lower sampling frequency for the same amount of data may deform the time-series signals.

The amount of data corresponds to the number of data of the time-series signal acquired during the acquisition. This amount of data is set by indicating a buffer memory size of the acquisition device to be used to acquire time-series signals. The larger the amount of data for the same sampling frequency, the more possible it is to observe more accurate details of the time-series signal in the frequency domain.

Furthermore, the amount of data should be set depending on the sampling frequency. Indeed, if the sampling frequency is too high and the amount of data is too small, then the acquisition time may be too short to acquire enough information in the time-series signal.

At a given sampling frequency, the larger the amount of data, the longer the acquisition time is. This makes it possible to observe more behaviors in the time-series signal acquired but this also results in a higher energy consumption, a longer waiting time for acquiring the time-series signal and a greater occupation of the memory for storing the acquired data.

A classification model is trained from acquired time-series signals. The sampling frequency and the amount of data have an impact on the trained classification model.

In particular, the classification model has performances that may vary according to the sampling frequency and the amount of data used to acquire the time-series signals provided to train this classification model.

The performances of a classification model are evaluated particularly with regard to an accuracy of the classification model, a period for acquiring the time-series signal to be used for the classification model (which impacts the energy consumption of the acquisition and the waiting time for acquiring the time-series signal) as well as the amount of data set for acquiring the time-series signal (which impacts the occupation of the memory for storing the acquired data).

Thus, it is advantageous to set the sampling frequency and the amount of data making it possible to obtain a classification model having optimal performances with regards to the needs of the user.

Conventionally, the user performs a plurality of acquisitions at different sampling frequencies and with different amounts of data in order to test which combination of sampling frequency and of amount of data makes it possible to obtain a classification model having optimal performances.

The user therefore carries out a trial and error search to determine the combination of sampling frequency and of amount of data making it possible to obtain a classification model having optimal performances.

This trial and error search requires carrying out a plurality of time-series signal acquisitions. These time-series signal acquisitions have the disadvantages of being time consuming and expensive. Furthermore, the trial and error search does not ensure that a classification model having optimal performances is obtained.

Thus, there is a need to propose a solution making it possible to facilitate the acquisition parameter search for acquiring the time-series signals used to train a classification model.

### SUMMARY

In accordance with an embodiment, a method implemented by computer for creating a classification model, referred to as final classification model, is proposed, the method comprising:
obtaining at least one group of initial time-series signals, the initial time-series signals being associated with at least one initial acquisition parameter,
creating at least one group of simulated time-series signals from the at least one group of initial time-series signals, the simulated time-series signals of each group being associated with at least one simulated acquisition parameter different from the at least one initial acquisition parameter,
creating various test classification models, each test classification model being created from at least one group of initial time-series signals or from the at least one group of simulated time-series signals, each test classification model being associated with at least one acquisition parameter corresponding to the at least one initial or simulated acquisition parameter associated with the initial or simulated time-series signals used to create this test classification model,
assessing the performances of each test classification model, the performances being associated with the at least one acquisition parameter of this test classification model, then
obtaining at least one group of final time-series signals associated with at least one final acquisition parameter selected from an analysis of the assessed performances of each test classification model, then
creating the final classification model from the at least one group of final time-series signals.

Such a method makes it possible to simplify the determination of the acquisition parameters to be applied for acquiring the final time-series signals used to create the final classification model.

Indeed, the acquisition of initial time-series signals is performed by an acquisition device, such as a sensor, according to at least one initial acquisition parameter. The performances of the test classification models are subsequently assessed from initial or simulated time-series signals and not acquired by the acquisition device.

The acquisition parameters to be applied for acquiring the final time-series signals are therefore determined from an analysis of the performances placed in relation with the acquisition parameters associated with the simulated time-series signals.

In particular, the acquisition parameters to be applied for acquiring the final time-series signals may be selected by analyzing which acquisition parameters make it possible to obtain optimal performances with regard to performance criteria set by the user.

This makes it possible to avoid carrying out an acquisition of time-series signals with various acquisition parameters to determine which acquisition parameters make it possible to create a classification model having optimal performances with regard to performance criteria set by the user.

By simplifying the search from the at least one final acquisition parameter, such a method thus makes it possible to reduce an overall cost of creating the final classification model because the latter may be obtained more easily and more rapidly.

In an advantageous implementation, the at least one initial acquisition parameter comprises a combination of an initial sampling frequency and of an initial amount of data from the initial time-series signals.

Advantageously, the initial sampling frequency corresponds to a maximum sampling frequency permitted by an acquisition device used to acquire the initial time-series signals.

In some embodiments, the initial amount of data corresponds to a maximum amount of data permitted by an acquisition device used to acquire the initial time-series signals.

In an advantageous implementation, the at least one simulated acquisition parameter from the simulated time-series signals of each group comprises a simulated sampling frequency less than or equal to the initial sampling frequency and an amount of simulated data less than or equal to the initial amount of data.

Advantageously, each group of initial time-series signals is associated with a class indicated during the obtaining of the initial time-series signals.

In an advantageous implementation, each group of simulated time-series signals is associated with the class indicated for the group of initial time-series signals from which this group of simulated time-series signals is created.

In some embodiments, the method further comprises extracting the feature values of the initial and simulated time-series signals, each test classification model being created from an analysis of the extracted feature values and of the class associated with each group of initial or simulated time-series signals used to create this test classification model.

In an advantageous implementation, the method further comprises extracting the feature values of the final time-series signals, each final classification model being created from an analysis of the extracted feature values and of the class associated with each group of final time-series signals.

In some embodiments, the method further comprises indicating the performances of each test classification model in relation with the at least one acquisition parameter associated with this test classification model.

Advantageously, the indication of the performances of each classification model comprises displaying on a screen a performance graph including the performances of each classification model according to the at least one associated acquisition parameter.

In an advantageous implementation, the assessed performances of each test classification model comprise an accuracy, an acquisition time of a time-series signal and an amount of acquired data for this time-series signal.

Advantageously, the method further comprises creating a computer program product comprising instructions which, when the program is executed by a computer, result in the latter implementing the final classification model.

In accordance with another embodiment, a computer program product is proposed comprising instructions which, when the program is executed by a computer, result in the latter implementing the method for creating a classification model as previously described.

In accordance with yet another embodiment, a computer system is proposed comprising:
a memory comprising a computer program product comprising instructions which, when the program is executed by a computer, result in the latter implementing the method for creating a classification model such as previously described,
a processing unit configured to execute the computer program product.

### BRIEF DESCRIPTION OF THE DRAWINGS

Other advantages and features of the invention will become apparent upon examining the detailed description of embodiments and implementations, without limitation, and of the appended drawings wherein:

FIG. 1 illustrates a computer system configured to implement a method for creating a classification model, in accordance with an embodiment;

FIG. 2 illustrates a method implemented by computer for creating a classification model of time-series signals, in accordance with an embodiment; and

FIG. 3 illustrates an example of a performance graph, in accordance with an embodiment.

### DETAILED DESCRIPTION OF ILLUSTRATIVE EMBODIMENTS

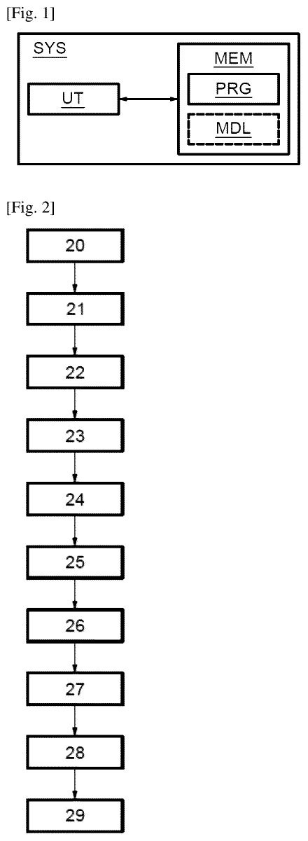

FIG. 1 illustrates one embodiment of a computer system SYS configured to implement a method for creating a classification model.

The computer system SYS comprises a processing unit UT (e.g., a processor such as a microprocessor, microcontroller, central processing unit, or the like) and a memory MEM. Such a computer system SYS may be a personal computer or a server for example.

The memory MEM includes a computer program PRG comprising instructions which, when the program PRG is executed by the processing unit UT of the computer system SYS, result in the latter implementing the method for creating a classification model MDL, such as described in the following.

The memory MEM is also configured to store time-series signals. These time-series signals serve as learning data for creating the classification model MDL.

The time-series signals may be provided by a user of the computer system SYS desiring to generate a classification model from these time-series signals.

The time-series signals may be acquired by sensors then provided to the computer system SYS. A time-series signal may for example correspond to an audio signal, a vibration signal or a physiological signal. The acquired time-series signals comprise a set of data acquired over time. The time-series signals may comprise a plurality of lines of data.

The time-series signals are associated with various classes. A class is a group of data that have similar features and that are grouped together depending on these features.

Thus, the time-series signals are divided into a plurality of groups of time-series signals, each group of time-series signals being associated with a class indicated by the user.

For example, a group of time-series signals may be associated with a class corresponding to signals corresponding to a normal operation, and another group of time-series signals may be associated with a class corresponding to anomaly signals.

The processing unit UT is configured to create a classification model MDL by implementing the creation method. In particular, the processing unit UT is configured to create a classification model MDL by executing the computer program PRG by taking as input time-series signals.

The time-series signals are acquired by an acquisition device (not shown). This acquisition device is configured to carry out an acquisition according to at least one acquisition parameter set by the user, such as a sampling frequency and an amount of data of the time-series signals.

The sampling frequency corresponds to a number of data samples of the time-series signal per unit of time. The higher the sampling frequency for the same amount of data, the higher the resolution is of the time-series signals in the time domain, this resolution corresponding to the value of the sampling frequency divided by the amount of data. Conversely, a lower sampling frequency for the same amount of data may deform the time-series signals.

The amount of data corresponds to the number of data of the time-series signal acquired during the acquisition. This amount of data is set by indicating a buffer memory size of the acquisition device to be used to acquire time-series signals. The larger the amount of data for the same sampling frequency, the more possible it is to observe more accurate details of the time-series signal in the frequency domain.

Furthermore, the amount of data should be set depending on the sampling frequency. Indeed, if the sampling frequency is too high and the amount of data is too small, then the acquisition time may be too short to acquire enough information in the time-series signal.

At a given sampling frequency, the larger the amount of data, the longer the acquisition time is. This makes it possible to observe more behaviors in the time-series signal acquired but this also results in a higher energy consumption, a longer waiting time for acquiring the time-series signal and a greater occupation of the memory for storing the acquired data.

The acquisition device makes it possible for the user to select a sampling frequency less than or equal to a maximum sampling frequency permitted by this acquisition device. The acquisition device makes it possible for the user to select an amount of data less than or equal to a maximum amount of data permitted by this acquisition device.

FIG. 2 illustrates one implementation of a method implemented by computer for creating a classification model of time-series signals.

The method aims to help select at least one acquisition parameter for acquiring the time-series signals to be used to create the classification model MDL.

For example, the method aims to help select a combination of sampling frequency and of amount of data for acquiring these time-series signals.

The method comprises obtaining 20 at least one group of initial time-series signals.

The initial time-series signals are acquired with a maximum sampling frequency permitted by the acquisition device. The initial time-series signals are also acquired with a maximum amount of data permitted by the acquisition device.

In this way, the initial time-series signals are sufficiently accurate to distinguish the various classes that are associated with them.

The method subsequently comprises creating 21 at least one group of simulated time-series signals from the initial time-series signals. Simulated time-series signals are thus obtained for the various classes studied. The simulated time-series signals make it possible to simulate acquisitions of time-series signals with acquisition parameters different from those used to acquire the initial time-series signals.

In particular, the simulated time-series signals are created with various sampling frequencies less than or equal to the maximum sampling frequency.

The simulated time-series signals are also created with various amounts of data that are less than or equal to the maximum amount of data.

More particularly, each simulated time-series signal uses data of the initial time-series signal. The use of a sampling frequency less than the maximum sampling frequency makes it possible to keep only part of the data of the time-series signal. The use of an amount of data less than the maximum amount of data makes it possible to reduce the amount of data in the simulated time-series signal in relation to the initial time-series signal. Each simulated time-series signal may have data of the initial time-series signal that are repeated in the simulated time-series signal. Each simulated time-series signal may also have a number of lines different from the initial time-series signal. Each line then includes the same amount of data. In order to assess the test classification models described in the following, it may be important to have a sufficient number of lines for each class. For example, it may be advantageous to use a minimum of one hundred lines per class.

The simulated time-series signals are used to assess the impact of the sampling frequencies and of the amounts of data on the accuracy of the classification.

In particular, the method comprises extracting 22 the feature values taken into account for classifying the initial time-series signals and simulated time-series signals.

For example, the features of the time-series signals may comprise amplitudes, frequencies, durations, minimums, maximums, averages, standard deviations, etc.

The method subsequently comprises, for each group of time-series signals, creating 23 a test classification model. Each test classification model is created from extracted feature values of the time-series signals used to create this classification model.

In some embodiments, the test classification model is created by using relatively rapid methods. For example, it is possible to create a test classification model by using a decision tree, a random forest classifier, a support-vector machine (SVM) or a k-nearest neighbor (KNN) method. The test classification models may thus be created without carrying out cross validation or without dividing the initial time-series signals into a set of learning signals and into a set of test signals.

Each test classification model is associated with a sampling frequency and with an amount of data corresponding to the sampling frequency and to the amount of data of the time-series signals used to create this test classification model.

Subsequently, the method comprises assessing 24 the performances of each test classification model. In particular, assessing the performances of each test classification model comprises determining the accuracy of this test classification model.

The accuracy of the test classification model is determined by comparing the class identified by the test classification model with the class entered by the user during the acquisition of the initial time-series signals.

Assessing the performances of each test classification model also comprises determining the acquisition time of time-series signals.

Assessing the performances of each test classification model may also comprise calculating a score. This score is then calculated depending on the various performance criteria to be assessed. For example, the performance score of each test classification model may be calculated depending on the accuracy of this test classification model, the acquisition time and the amount of data associated with this test classification model. This performance score may particularly be set by a weighting of the various performance criteria assessed. The user may also set test constraints such as a maximum acquisition period and/or a maximum amount of data per line.

The method subsequently comprises indicating 25 the performances of each test classification model created in relation with the sampling frequency and the amount of data associated with this test classification model.

For example, the performances may be displayed on a screen of the computer system SYS. A performance graph may for example be created by the computer system then displayed on the screen.

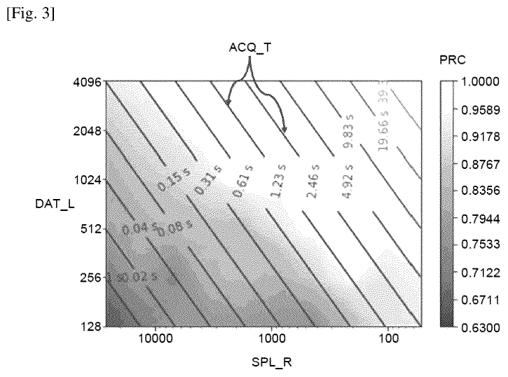

An example of such a performance graph is illustrated in FIG. 3. The performance graph shows the performances in relation to the accuracy PRC and to the acquisition time ACQ_T of time-series signals according to the sampling frequencies SPL_R (in Hz) and the amounts of data DAT_L (in number of bits) associated with these models.

From the performances indicated, the user may select the acquisition parameters to be used to acquire the final time-series signals.

In particular, the user may select the sampling frequency and the amount of data associated with the classification model having obtained an optimum performance with regard to the needs of the user. In some embodiments, this selection is performed automatically from criteria entered by the user. Alternatively, it is possible to suggest to the user certain combinations of sampling frequency and of amount of data obtaining the best performances.

The user may subsequently use the acquisition device to acquire groups of final time-series signals associated with the various classes set. These final time-series signals are acquired by using the combination of sampling frequency and of amount of data selected.

The method subsequently comprises obtaining 26 these final time-series signals. In particular, these final time-series signals are provided as input for the computer program PRG.

The method subsequently comprises extracting 27 the feature values of the final time-series signals.

The method subsequently comprises creating 28 a final classification model from these final time-series signals.

In particular, the final classification model is created from extracted feature values of the final time-series signals used to create this classification model. The classification model may be obtained by methods other than that used to create the test classification models. For example, the final classification model may be created from a more advanced method than that used to create the test classification models. This makes it possible to obtain a more accurate final classification model. In particular, the final classification model may be an artificial neural network.

The method subsequently comprises creating 29 a computer program comprising instructions which, when the program is executed by a computer, result in the latter implementing the final classification model.

Such a computer program may subsequently be used by a computer, for example by a microcontroller to perform a classification of time-series signals of the same type as those used to train the final classification model by using the final classification model.

More particularly, the performance criteria set by the user used to analyze the performances of the test classification models may be selected depending on the computer that will execute the final classification model.

Such a method makes it possible to simplify the search for a combination of sampling frequency and of amount of data for acquiring the final time-series signals used to create the final classification model.

Indeed, the acquisition of initial time-series signals is performed according to a single combination of sampling frequency and of amount of data. The performances of the test classification models are subsequently assessed from simulated time-series signals and not acquired by the acquisition device.

By simplifying the search for the combination of sampling frequency and of amount of data for acquiring the final time-series signals, such a method also makes it possible to reduce an overall cost of creating the final classification model because the latter may be obtained more rapidly.

Such a method also has the advantage of being able to be fully automated. In this case, the final selection of the combination of sampling frequency and of the amount of data is carried out automatically according to performance criteria entered by the user.

What is claimed is:

1. A method for creating a classification model, the method comprising:
obtaining at least one group of initial time-series signals, the initial time-series signals being associated with at least one initial acquisition parameter;
creating at least one group of simulated time-series signals from the at least one group of initial time-series signals, the simulated time-series signals of each group being associated with at least one simulated acquisition parameter different from the at least one initial acquisition parameter;
creating various test classification models, each test classification model being created from at least one group of initial time-series signals or from the at least one group of simulated time-series signals, each test classification model being associated with at least one acquisition parameter corresponding to the at least one initial or simulated acquisition parameter associated with the initial or simulated time-series signals used to create this test classification model;
assessing the performances of each test classification model, the performances being associated with the at least one acquisition parameter of this test classification model;
obtaining at least one group of final time-series signals associated with at least one final acquisition parameter selected from an analysis of the assessed performances of each test classification model; and
creating the classification model from the at least one group of final time-series signals.

2. The method according to claim 1, wherein the at least one initial acquisition parameter comprises a combination of an initial sampling frequency and of an initial amount of data from initial time-series signals.

3. The method according to claim 2, wherein the initial sampling frequency corresponds to a maximum sampling frequency permitted by an acquisition device used to acquire the initial time-series signals.

4. The method according to claim 2, wherein the initial amount of data corresponds to a maximum amount of data permitted by an acquisition device used to acquire the initial time-series signals.

5. The method according to claim 2, wherein the at least one simulated acquisition parameter from the simulated time-series signals of each group comprises a simulated sampling frequency less than or equal to the initial sampling frequency and an amount of simulated data less than or equal to the initial amount of data.

6. The method according to claim 1, wherein each group of initial time-series signals is associated with a class indicated during the obtaining of initial time-series signals.

7. The method according to claim 6, wherein each group of simulated time-series signals is associated with the class indicated for the group of initial time-series signals from which this group of simulated time-series signals is created.

8. The method according to claim 7, further comprising extracting the feature values of the initial and simulated time-series signals, each test classification model being created from an analysis of the extracted feature values and of the class associated with each group of initial or simulated time-series signals used to create this test classification model.

9. The method according to claim 8, further comprising extracting the feature values of the final time-series signals, the classification model being created from an analysis of the extracted feature values and of the class associated with each group of final time-series signals.

10. The method according to claim 1, further comprising creating a computer program product comprising instructions which, when the program is executed by a computer, result in the latter implementing the classification model.

11. A method for creating a classification model, the method comprising:
obtaining at least one group of initial time-series signals, the initial time-series signals being associated with at least one initial acquisition parameter;
creating at least one group of simulated time-series signals from the at least one group of initial time-series signals, the simulated time-series signals of each group being associated with at least one simulated acquisition parameter different from the at least one initial acquisition parameter;
creating various test classification models, each test classification model being created from at least one group of initial time-series signals or from the at least one group of simulated time-series signals, each test classification model being associated with at least one acquisition parameter corresponding to the at least one initial or simulated acquisition parameter associated with the initial or simulated time-series signals used to create this test classification model;
assessing the performances of each test classification model, the performances being associated with the at least one acquisition parameter of this test classification model; and
indicating the performances of each test classification model in relation with the at least one acquisition parameter associated with this test classification model.

12. The method according to claim 11, wherein the indication of performances of each classification model comprises displaying on a screen a performance graph including the performances of each classification model according to the at least one associated acquisition parameter.

13. The method according to claim 11, wherein the assessed performances of each test classification model comprise an accuracy, an acquisition time of a time-series signal, and an amount of acquired data for this time-series signal.

14. A computer system comprising:
a memory comprising a computer program, the computer program comprising instructions to:
obtain at least one group of initial time-series signals, the initial time-series signals being associated with at least one initial acquisition parameter;
create at least one group of simulated time-series signals from the at least one group of initial time-series signals, the simulated time-series signals of each group being associated with at least one simulated acquisition parameter different from the at least one initial acquisition parameter;
create various test classification models, each test classification model being created from at least one group of initial time-series signals or from the at least one group of simulated time-series signals, each test classification model being associated with at least one acquisition parameter corresponding to the at least one initial or simulated acquisition parameter associated with the initial or simulated time-series signals used to create this test classification model;
assess the performances of each test classification model, the performances being associated with the at least one acquisition parameter of this test classification model;
obtain at least one group of final time-series signals associated with at least one final acquisition parameter selected from an analysis of the assessed performances of each test classification model; and
create the classification model from the at least one group of final time-series signals; and
a processor configured to execute the computer program.

15. The computer system according to claim 14, wherein the at least one initial acquisition parameter comprises a combination of an initial sampling frequency and of an initial amount of data from initial time-series signals.

16. The computer system according to claim 15, wherein the initial sampling frequency corresponds to a maximum sampling frequency permitted by an acquisition device used to acquire the initial time-series signals.

17. The computer system according to claim 15, wherein the initial amount of data corresponds to a maximum amount of data permitted by an acquisition device used to acquire the initial time-series signals.

18. The computer system according to claim 15, wherein the at least one simulated acquisition parameter from the simulated time-series signals of each group comprises a simulated sampling frequency less than or equal to the initial sampling frequency and an amount of simulated data less than or equal to the initial amount of data.

19. The computer system according to claim 14, wherein each group of initial time-series signals is associated with a class indicated during the obtaining of initial time-series signals.

20. The computer system according to claim 14, further comprising indicating the performances of each test classification model by displaying on a screen a performance graph including the performances of each classification model according to the at least one associated acquisition parameter, the screen being coupled with the computer system.
